(19) United States
(12) Patent Application Publication
(10) Pub. No.: US 2006/0198392 A1
(43) Pub. Date: Sep. 7, 2006

(54) Transcoding apparatus and method for seamless multimedia content transmission

(75) Inventors: Jeong-Rok Park, Hwaseong-si (KR); Kwan-Lae Kim, Yongin-si (KR); Jeong-Seok Choi, Seoul (KR); Yun-Je Oh, Yongin-si (KR); Jun-Ho Koh, Suwon-si (KR)

Correspondence Address: CHA & REITER, LLC, 210 ROUTE 4 EAST STE 103, PARAMUS, NJ, 07652, US

(73) Assignee: Samsung Electronics Co., LTD.

(21) Appl. No.: 11/301,538

(22) Filed: Dec. 13, 2005

(30) Foreign Application Priority Data
Dec. 13, 2004 (KR) 2004-105157

(51) Int. Cl. H04J 1/16; H04J 3/22

(52) U.S. Cl. 370/468; 370/252

(57) ABSTRACT

An apparatus and method is disclosed for seamlessly transmitting video content to a terminal in a communication system which supports a multimedia service. The apparatus generally comprises a transcoding information generation unit for generating transcoding information for performing a transcoding operation in consideration of the bandwidth of a network, a transcoding unit for adaptively transcoding video content to be transmitted according to the generated transcoding information; and a database server for storing the video content to be transmitted from the apparatus to the terminal.

### CLAIM OF PRIORITY

This application claims the benefit under 35 U.S.C. 119(a) of an application entitled “Transcoding Apparatus And Method For Seamless Video Content Transmission,” filed in the Korean Intellectual Property Office on Dec. 13, 2004 and assigned Serial No. 2004-105157, the entire contents of which are incorporated herein by reference.

### BACKGROUND OF THE INVENTION

1. Field of the Invention

The present invention generally relates to a system for transmitting multimedia content through a network, and more particularly, to a method and apparatus that adaptively performs a transcoding operation on multimedia content to be transmitted through a network.

2. Description of the Related Art

Recent developments in computer and wired/wireless communication technologies have spurred an increase in the transmission of high-quality digital media content, such as, for example, digital broadcasting and DVD. In this regard, many additional applications and programs for reproducing such high-quality digital media content are being proposed, thereby increasing the demand for high-quality digital media content services.

FIG. 1 is a block diagram schematically illustrating the structure of a prior-art communication system supporting a high-quality digital media content service. A communication terminal 100 is configured to transmit and receive data communication signals. The terminal 100 may be embodied, for example, as a PC, PDA, wireless notebook computer, desktop computer, and so on. The communication terminal 100 is shown connected to a network 110 to transmit/receive video content to/from a video server 120.

The network 110 allocates a communication channel for communicating with the terminal 100. The terminal 100 manages subscriber information, location information and charging information according to the transmission/reception of various video content.

The video server 120 is configured to efficiently manage and search for data accumulated from one or more data sources. A data source may include, for example, a broadcasting station, advertisement agency, film producing company, etc. Each data source is configured to record, edit, and transmit video content and audio data. The video server 120 is further configured to store, manage and transmit digital video. More particularly, the video server 120 compresses video content and audio data and manages uncompressed data, stored in a database 170, to facilitate searches for video content and audio data.

Herein, multimedia content transmitted from the video server 120 to the terminal 100 refers to data having a bandwidth of approximately 4 to 20 Mbps, or is otherwise high-speed data for providing a real-time service. A drawback of the communication system of FIG. 1 is that the video server 120 transmits video content to the terminal 100 without taking into consideration the wireless environment of the terminal 100, as well as the bandwidth of the network 110. This can be problematic in the case where a large number of terminals are simultaneously accessing the network 110. The video server 120 transmits video content to each terminal without taking into consideration the limited bandwidth of the network 110, resulting in a diminished quality of service for each terminal. Therefore, when the bandwidth of the network 110 changes, the changed bandwidth is not reflected in the service provided by the video server 120. As a result, when the bandwidth of the network 110 is reduced, the transmitted video content may become unavailable for downloading to the terminals requesting such content.

In another scenario, in which the video server 120 transmits video content at a high transmission rate, if the network 110 is operating with a reduced bandwidth, transmission of the video content from the video server 120 across the network 110 may be unachievable.

Therefore, it would be desirable to have a communication system that adaptively transmits multimedia content in consideration of the bandwidth of the network 110, the wireless environment, the state of the receiving terminals, and a service level agreement between a provider of the multimedia content and receiving parties.

### SUMMARY OF THE INVENTION

Accordingly, the present invention solves the above-mentioned and other problems in the prior art by providing a method and apparatus for enabling a video server to adaptively transcode and transmit video content in a system configured to transmit multimedia content across a network.

The present invention further provides a method and apparatus for enabling a video server to vary the transmission rate of video content dependent upon the bandwidth of the network and the state of a terminal in a system configured to transmit multimedia content across a network.

According to one aspect, there is provided an apparatus for transmitting multimedia content to a terminal in a communication system which supports a multimedia service, the apparatus comprising: a transcoding information generation unit for generating transcoding information for performing a transcoding operation while taking into consideration a bandwidth of a network communicating with the terminal; a transcoding unit for adaptively transcoding video content to be transmitted according to the transcoding information; and a database server for storing the video content.

In accordance with another aspect, there is provided a method for transmitting video content to a terminal in a communication system which supports a multimedia service, the method comprising the steps of: generating initial transcoding information for performing a transcoding operation in consideration of information about performance of the terminal and information about a service level agreement; receiving information about a bandwidth of a network, which makes communication with the terminal, and generating adaptive transcoding information; and transcoding video contents for transmission according to the transcoding information, and transmitting the transcoded video contents to the terminal.

In accordance with still another aspect, there is provided a system for seamlessly transmitting multimedia content, the system comprising: a terminal for requesting the multimedia contents; a network for making communication with the terminal through transmission control protocol/internet protocol (TCP/IP); and a video server for generating transcoding information in order to transcode multimedia contents for transmission in accordance with Codec and performance information of the terminal and a bandwidth of the network, and performing the transcoding operation.

### BRIEF DESCRIPTION OF THE DRAWINGS

FIG. 1 is a block diagram of a prior-art communication system supporting a high-quality digital media content service, according to the prior art;

FIG. 2 is a block diagram of a system for performing a transcoding operation to transmit multimedia content, according to an embodiment of the present invention;

FIGS. 3A and 3B are flowcharts describing the operation of the transcoding information generation unit of FIG. 2, according to an embodiment of the present invention; and

FIGS. 4A and 4B are flowcharts describing the operation of the transcoding unit of FIG. 2, according to an embodiment of the present invention.

### DETAILED DESCRIPTION

Hereinafter, one embodiment according to the present invention will be described with reference to the accompanying drawings. For the purposes of clarity and simplicity, a detailed description of known functions and configurations incorporated herein will be omitted as it may obscure the subject matter of the present invention. The definition of the following terminologies must be interpreted based on the overall content disclosed in the description.

Recently, with the development of computer and wired/wireless communication technologies and with the commercialization of digital television, various multimedia services, such as, for example, Video on Demand (VOD), video conferencing, telemedicine, and tele-education have experienced increased growth. In accordance with such developments, the present invention provides a method and apparatus which supports a stable and reliable real-time multimedia service, More particularly, the present invention provides a system and method for transcoding video content to seamlessly transmit data in support of the afore-mentioned multimedia services.

In one aspect, the invention provides a transcoding method that adaptively controls the transmission rate of a bit stream. The bit stream is characterized as having a high bit rate and comprises multimedia data including, for example, high-quality video.

In another aspect, the present invention provides an apparatus and method for adaptively varying the transmission rate of the bit stream in consideration of the bandwidth of the network, thereby ensuring the quality of the multimedia service.

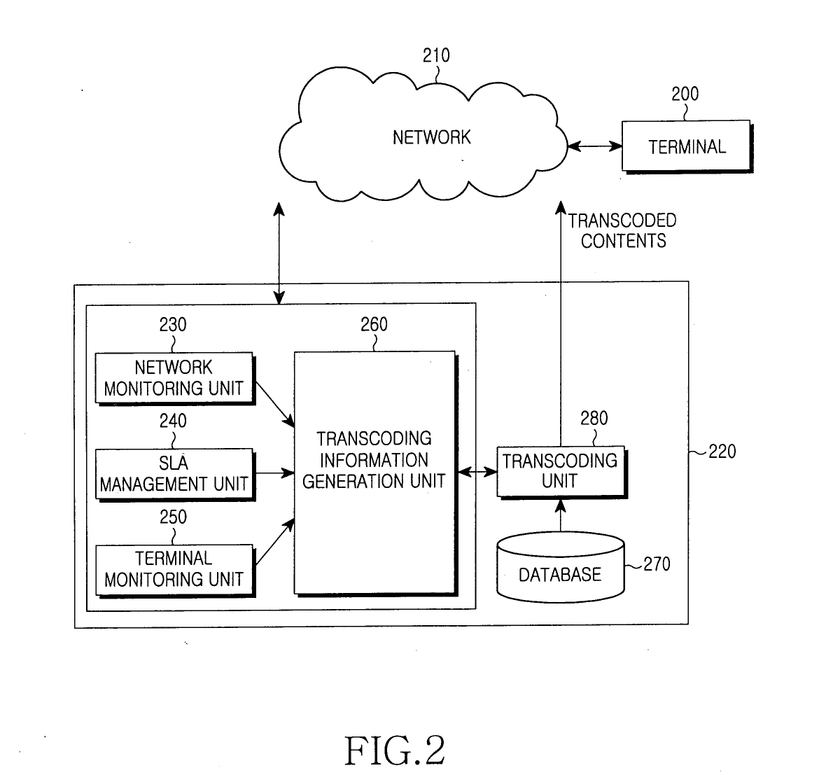

In accordance with an exemplary embodiment, FIG. 2 is a block diagram illustrating a system, according to invention principles, for performing a transcoding operation to seamlessly transmit video content across a network.

The system of FIG. 2 includes a communication terminal 200 for transmitting and receiving data communication signals. The terminal 200 may be embodied, for example, as a PC, personal digital assistant (PDA), wireless notebook computer, cable desktop computer, etc. The terminal 200 is shown connected to a network 210, which allocates a channel, to transmit/receive video content to/from a video server 220. The terminal 200 transmits information about its performance capabilities to the video server 220 through the network 210. By providing such information, the terminal 200 can be provided with a multimedia service including the reception of bit streams transcoded in accordance with the terminal's performance. The network 210 allocates a channel for communicating with the terminal 200. The terminal 200 manages subscriber information, location information and charging information in accordance with the transmission/reception of video content.

The video server 220 manages and searches for video content, sourced from content producers, to be stored, managed and transmitted over the network 210. The video server 220 includes a transcoding unit 280 for transcoding video content in consideration of the terminal's 200 performance capabilities and the bandwidth of the network 210.

The video server 220 further includes a contents database 270 for managing video content retrieved from the various content providers.

The video server 220 further includes a network monitoring unit 230 for monitoring the bandwidth of the network 210, and for transmitting the monitored bandwidth information to the transcoding information generation unit 260. Specifically, the network monitoring unit 230 monitors the network 210 to determine whether the network bandwidth is increasing or decreasing, and transmits this information to the transcoding information generation unit 260.

In one embodiment, the network bandwidth is monitored by the network monitoring unit 230 using both an active monitoring scheme and a passive monitoring scheme, described as follows.

The active monitoring scheme obtains the values of two parameters, N and M, which represent, respectively, the number of frames in a picture group of a video stream and a time interval between consecutive P pictures.

The two parameters, N and M, are obtained using a transmitting test apparatus installed at a desired section of the network. A predetermined test packet is then transmitted from the transmitting test apparatus to a receiving test apparatus located at another section of the network to obtain the measured values of N and M. The active monitoring scheme includes Surveyor™, RIPE NCC Test Traffic™, PingER™, NLANR AMP™,Skitter™,etc.

The passive monitoring scheme detects the state of the network by checking actual traffic packets passing through the network. In contrast to the active monitoring scheme, which manages test traffic, the passive monitoring scheme analyzes the network 210 based on the amount of real or actual traffic packets passing through the network 210. For this reason, the passive monitoring scheme provides a more realistic determination of the actual state of the network 210.

The video server 220 further includes a service level agreement (SLA) management unit 240 which allocates an initial bandwidth between the video server 220 and the terminal 200 using a service level agreement (SLA) established between an internet service provider (ISP) and an operator of the terminal 200. The service level agreement includes information about the percentage of time that a service can be provided, the number of users to which service can be provided at the same time, and statistics of packet data to be provided. In addition to its allocation function, the SLA management unit 240 also determines a transcoding transmission rate of video content.

The video server 220 further includes a terminal monitoring unit 250 which monitors terminal 200 accesses to the network 210, and also monitors the state of the terminal 200. The terminal monitoring unit 250 receives information relating to various terminal characteristics including, for example, terminal resolution, Codec type, the size of a video memory and the power of the terminal. The terminal characteristics are provided to the transcoding information generation unit 260. The terminal monitoring unit 250 receives information about the state of the terminal 200 over the network 210 using transmission control protocol/internet protocol (TCP/IP). In one embodiment, the terminal monitoring unit 250 receives the information through a server communication programming scheme (socket programming) of the TCP/IP.

As described above, the transcoding information generation unit 260 receives information from the network monitoring unit 230, the SLA management unit 240 and the terminal monitoring unit 250. The information is used by the transcoding information generation unit 260 to establish an initial transcoding value to be supplied to the transcoding unit 280 to vary the transcoding rate in real time.

In operation, the transcoding information generation unit 260 periodically receives a current measure of the bandwidth of the network 210 from the network monitoring unit 230, information about the service level agreement between the terminal 200 and a service provider from the SLA management unit 240, and information about the state of performance capabilities of the terminal 200 from the terminal monitoring unit 250. From the supplied information, the transcoding information generation unit 260 generates an initial transcoding value and a transmission rate to be provided to the transcoding unit 280.

The transcoding unit 280 transcodes video content stored in the contents database 270, according to the transcoding information. Also, the transcoding unit 280 transmits the video content by varying the video transmission format of the video content to be transmitted in accordance with the transcoding information. That is, the transcoding unit 280 transmits the video content to the terminal 200 while varying a bit rate in the same video format and varying the video transmission format.

The video transcoding method normally includes a bit rate conversion scheme for converting a high bit-rate stream transmitted from the video server to a low bit-rate stream, a frame rate conversion scheme of converting a high frame-rate stream to a low frame-rate stream, and a resolution conversion scheme of converting the resolution of video.

The system shown in FIG. 2 is based on a transcoding method by the conversion schemes. In particular, the transcoding method performs an adaptive transcoding operation according to two factors, the wireless environment of the network 210 and the performance capabilities of the terminal 200. Consequently, a bit stream, which has been adaptively transcoded in the transcoding unit 280, is standardized into a format for supporting a VOD service for transmission to the terminal 200.

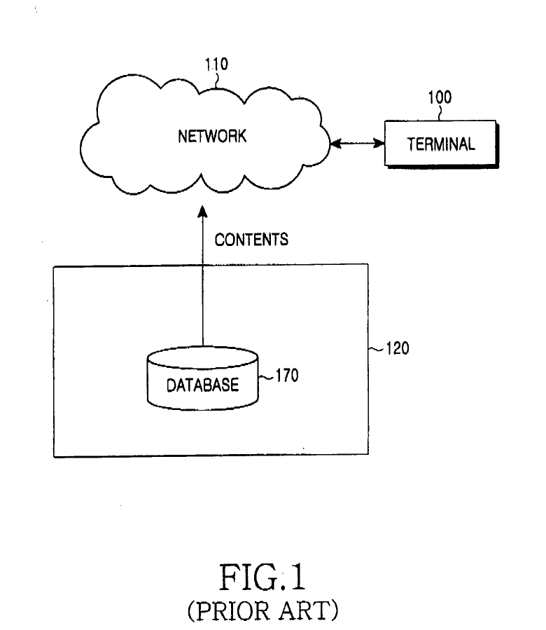

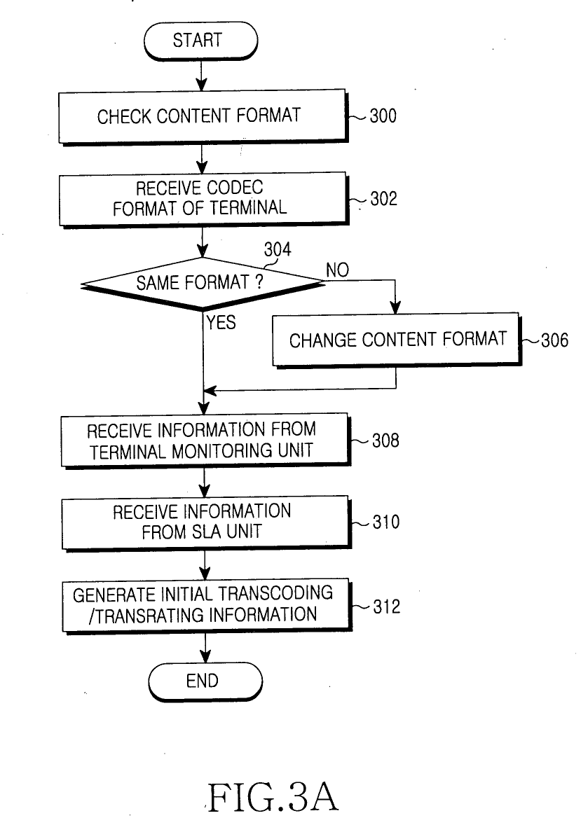

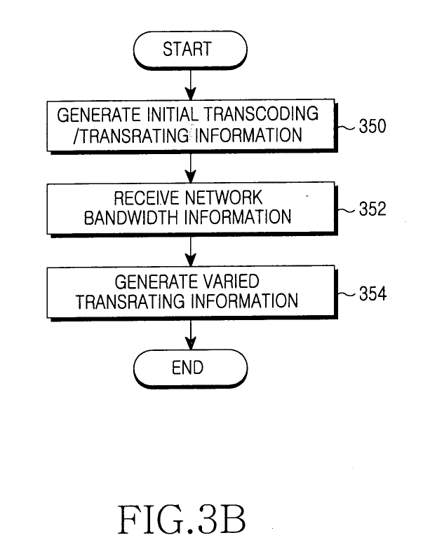

FIGS. 3A and 3B illustrate example flowcharts for describing the operation of the transcoding information generation unit 260 of FIG. 1.

FIG. 3A is an example flowchart for describing a procedure for generating initial transcoding information in the transcoding information generation unit 260 (as shown in FIG. 1).

In step 300, the transcoding information generation unit 260, determines the transmission format of video content to be transmitted from the video server contents database 270 to the terminal 200.

In step 302, the transcoding information generation unit 260 checks the Codec information of the terminal 200 supplied from the terminal monitoring unit 250. The Codec information comprises information for converting a radio signal including analog content information into a radio signal including digital video content information, and is used by the terminal 200 to reproduce the received radio signal including digital video information.

In determination step 304, the transcoding information generation unit 260 determines whether the transmission format of the video content to be transmitted is identical to the Codec information of the terminal 200. In the case where the transmission format of the video content to be transmitted is identical to the Codec information of the terminal 200, the process continues to step 308. Otherwise, the process continues at step 306.

In step 306, the format of the video content is changed because it was determined not to be identical to the Codec information of the terminal 200 at step 304. In step 308, the transcoding information generation unit 260 receives terminal performance information (e.g. the resolution of the terminal, the required power, the memory size) from the terminal monitoring unit 250.

In step 310, the transcoding information generation unit 260 receives information about a service level, on which the terminal and a service provider both agree. The service level is provided by the SLA management unit 240.

In step 312, the transcoding information generation unit 260 establishes an initial transcoding value as a function of the terminal performance information (step 308) and service level information (step 310). The transcoding information generation unit 260 also establishes an initial transcoding value for transmitting the transcoded video content.

FIG. 3B is a flowchart explaining a procedure for adaptively varying transcoding information dependent upon the bandwidth of the network.

In step 350, the transcoding information generation unit 260 transmits the initial transcoding value and initial transrating value to the transcoding unit 280 (see step 312 of FIG. 3a).

In step 352, the transcoding information generation unit 260 receives information about the bandwidth of the network 210 from the network monitoring unit 230. As described above, the network monitoring unit 230 periodically transmits information about the bandwidth of the network to the transcoding information generation unit 260.

In step 354, the transcoding information generation unit 260 varies the transmission rate for transmitting the video content dependent on the bandwidth information received from the network monitoring unit 230. When the effective transmission bandwidth of the network is reduced, the transcoding information generation unit 260 responsively decreases the bit rate and then transmits the video content. Otherwise, when the effective transmission bandwidth of the network is increased, the transcoding information generation unit 260 responsively increases the bit rate and then transmits the video content.

The flowcharts of FIGS. 3a and 3b clearly illustrate that the transcoding information generation unit 260 adaptively varies and establishes the transcoding and transrating values based on the sum of information transmitted from the network monitoring unit 230, the SLA management unit 240 and the terminal monitoring unit 250. The transcoding information generating unit 260 in turn supplies transcoding information and bit rate information to the transcoding unit 280.

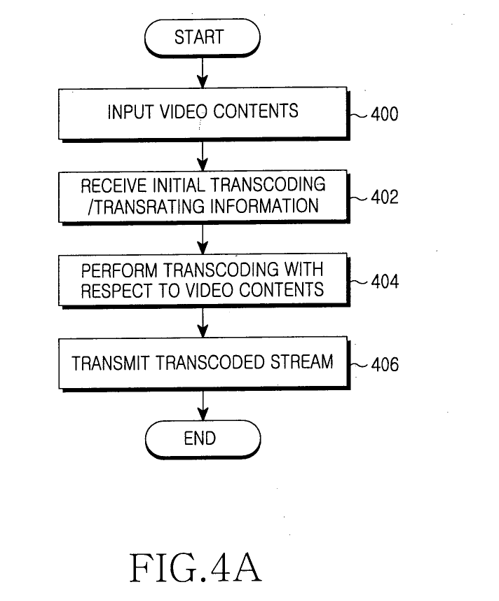

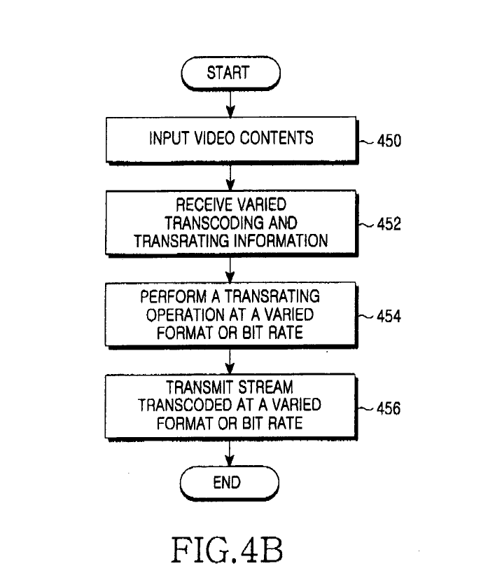

FIG. 4A illustrates an example flowchart describing the operation of the transcoding unit 280 when generating initial transcoding information.

In step 400, which represents an initial state of the transcoding unit, the transcoding unit 280 determines that video content needs to be transmitted from the contents database 270.

In step 402, the transcoding unit 280 receives the initial transcoding information and initial transrating information from the transcoding information generation unit 260.

In step 404, the transcoding unit 280 performs a transcoding operation based on the initial transcoding information supplied from the transcoding information generating unit 260.

In step 406, the transcoding unit 280 seamlessly transmits a transcoded video stream to the terminal 200 over the network 210.

FIG. 4B illustrates an example flowchart describing the adaptive transcoding operation.

In step 450, the transcoding unit 280 transmits video content across the network 210, transcoded according to transcoding information established at step 402 of FIG. 4A.

In step 452, the transcoding unit 280 receives transcoding and transrating information, which has been adaptively established dependent upon the bandwidth of the network 210, the performance of the terminal 200, and a service level, from the transcoding information generation unit 260.

In step 454, the transcoding unit 280 transcodes the video content to be transmitted over the network 210 by varying the bit rate of the video content or by varying the transmission format according to the transcoding and transrating information received at step 452. The bit rate or the transmission format is determined randomly according to the embodiment of the present invention.

In step 456, the transcoding unit 280 transmits the video stream to the terminal 200, transcoded by varying the bit rate and transmission format.

An important advantage provided by the present invention is the ability of a terminal to seamlessly receive and download video content from a video server without interruption by adaptively varying the data transmission rate of the downloaded video content dependent upon the bandwidth of the network and the state of the terminal.

While the present invention has been shown and described with reference to certain preferred embodiments thereof, it will be understood by those skilled in the art that various changes in form and details may be made therein without departing from the spirit and scope of the invention as defined by the appended claims. Accordingly, the scope of the invention is not to be limited by the above embodiments but by the claims and the equivalents thereof.

What is claimed is:

1. An apparatus for transmitting video content to a terminal in a communication system which supports a multimedia service, the apparatus comprising:
a transcoding information generation unit for generating transcoding information, said transcoding information utilized to perform a transcoding operation on video content to be transmitted from a server device to at least one terminal in the communication system, the transcoding information being dependent in part upon a measure of network bandwidth over which said video content is transmitted;
a transcoding unit for adaptively transcoding video content to be transmitted according to the transcoding information; and
a database server for storing the video content to be transmitted.

2. The apparatus as claimed in claim 1, wherein the apparatus further comprises a network monitoring unit for monitoring the bandwidth of the network and periodically providing the bandwidth monitoring information to the transcoding information generation unit.

3. The apparatus as claimed in claim 2, wherein the transcoding information generation unit periodically receives information about the network bandwidth.

4. The apparatus as claimed in claim 1, further comprising a service level management unit for providing information about a service level agreement.

5. The apparatus as claimed in claim 1, further comprising a terminal monitoring unit for providing terminal performance information to the transcoding information generation unit.

6. The apparatus as claimed in claim 5, wherein the terminal performance information comprises a resolution size, a memory size, and power of the terminal.

7. The apparatus as claimed in claim 1, wherein the transcoding information generation unit receives Codec information of the terminal comprising information for converting a radio signal including analog video content information into a radio signal including digital video content information.

8. The apparatus as claimed in claim 7, wherein the transcoding information generation unit generates adaptive transcoding information for performing the transcoding operation, in dependence upon information received from a network monitoring unit, a service level management unit, and a terminal monitoring unit.

9. The apparatus as claimed in claim 1, wherein the transcoding unit performs a transcoding operation, while varying a format and a bit rate of the video content for transmission according to the transcoding information.

10. A method for transmitting video content from a server device to a terminal in a communication system, which supports a multimedia service, the method comprising the steps of:
generating initial transcoding information for performing a transcoding operation on video content to be transmitted from said server device to said terminal, the transcoding information generated in accordance with terminal performance information and service level agreement information;
receiving information about a bandwidth of a network, over which said multimedia service operates;
generating adaptive transcoding information from said initial transcoding information responsive to said bandwidth information;
transcoding video content for transmission according to the adaptive transcoding information; and
transmitting the transcoded video content to the terminal.

11. The method as claimed in claim 10, wherein the initial transcoding information is created based on Codec information received from the terminal.

12. The method as claimed in claim 10, wherein the terminal performance information comprises, at least one of, a resolution size of the terminal, a memory size of the terminal, and power information of the terminal.

13. The method as claimed in claim 10, wherein the service level agreement is an agreement reached between a terminal operator and a video content provider.

14. The method as claimed in claim 10, wherein the adaptive transcoding information is created based on information about a bandwidth of the network.

15. The method as claimed in claim 10, further comprising a step of varying a format of the video content while performing said transcoding operation.

16. The method as claimed in claim 10, further comprising a step of varying a bit transmission rate of the video content while performing said transcoding operation.

17. A system for seamlessly transmitting multimedia content, the system comprising:
a terminal for requesting the multimedia content;
a network for communicating with the terminal via the transmission control protocol/internet protocol (TCP/IP); and
a video server for generating transcoding information in accordance with terminal Codec information, terminal performance information, and a bandwidth of the network, and for performing a transcoding operation on the requested multimedia content.

18. The system as claimed in claim 17, wherein the video server comprises:
a terminal monitoring unit for monitoring a state of the terminal;
a network monitoring unit for monitoring a bandwidth of the network;
a service level management unit for managing information about a service level agreement between the terminal and a multimedia content provider;
a transcoding information generation unit for generating the transcoding information in consideration of information provided by said terminal monitoring unit and said network monitoring unit; and
a transcoding unit for adaptively varying a format and a bit rate of the multimedia content according to the transcoding information generated by the transcoding information generation unit.
